(19) United States
(12) Patent Application Publication
(10) Pub. No.: US 2016/0021351 A1
(43) Pub. Date: Jan. 21, 2016

(54) OPTICAL SYSTEM AND DEVICE HAVING OPTICAL SYSTEM

(71) Applicant: NITTOH KOGAKU K.K., Suwa-shi, Nagano (JP)

(72) Inventors: Akira YAMAGISHI, Nagano (JP); Akira SAWAMOTO, Nagano (JP)

(73) Assignee: NITTOH KOGAKU K.K., Suwa-shi, Nagano (JP)

(21) Appl. No.: 14/774,218

(22) PCT Filed: Mar. 14, 2014
(86) PCT No.: PCT/JP2014/001457

§ 371 Date: Sep. 10, 2015

(30) Foreign Application Priority Data
Mar. 14, 2013 (JP) 2013-051429

(51) Int. Cl. H04N 9/31; G03B 21/53; G02B 27/10; G03B 21/14; G03B 21/28

(52) U.S. Cl. CPC H04N 9/3194; G03B 21/142; G03B 21/28; G02B 27/1006; G03B 21/53

(57) ABSTRACT

An optical system (1) includes: a first lens system (10) that emits light (51a) of a visible light band incident from a light modulating device (60) side toward a projection side; and an optical device (30) that separates proximate light (52b), which is adjacent to the visible light band and is light of a non-visible light band that is incident on the first lens system (10) from the projection side, from an optical path (41) of the first lens system (10) and outputs toward an image pickup device (70) side.

### TECHNICAL FIELD

The present invention relates to an optical system capable of projection and image pickup and an apparatus including such optical system.

### BACKGROUND ART

Japanese Laid-Open Patent Publication No. 2008-292570 (hereinafter, “Document 1”) discloses, for a projector which is equipped with an image pickup means capable of picking up projected images projected onto a screen via a projection lens and which adjusts the focus of the projected images using the image pickup means, a technology capable of improving the precision of focus adjustments and of simplifying the apparatus configuration. To do so, Document 1 discloses a projection-type image display apparatus which includes a projection means that emits projection light, to which images are added, via a projection lens and an image pickup means that captures projected images projected by the projection means via an image pickup lens, captures, using the image pickup means, the projected images on a screen that have been projected by the projection means, and adjusts the focus of the projected images based on the image pickup result, wherein the projection lens and the image pickup lens are configured so as to be moveable by a same driving means in a direction that changes the focus of the projected images or the focus of the picked up images.

### DISCLOSURE OF THE INVENTION

In a variety of applications such as presentations and schools and education, projector apparatuses (projectors) equipped with an image pickup function have been proposed. In the technology disclosed in Document 1, a projection lens and an image pickup lens are separately provided.

One aspect of the present invention is an optical system including: a first lens system that emits light of a visible light band incident from a light modulating device side toward a projection side; and an optical device that separates proximate light, which is adjacent to the visible light band and is light of a non-visible light band that is incident on the first lens system from the projection side, from an optical path of the first lens system and outputs toward an image pickup device side.

In this optical system it is possible to optimize the first lens system as a projection lens system that emits visible light incident on the first lens system from the light modulating device side to the projection side. In addition, by using the first lens system in the opposite direction, it is possible to output proximate light that is incident on the first lens system from the projection side toward the image pickup device side via the optical device. Accordingly, it is possible to commonly use the first lens system for projection and image pickup, and by using the first lens system in opposite directions for projection and image pickup, it is possible to pick up using proximate light that propagates in the opposite direction to the projection light propagating toward the projection side. This means that it is possible to use the visible light that is incident on the first lens system as projection light without a fall in the amount of light. Accordingly, it is possible to project bright, sharp images using a first lens system that is optimized for visible light.

It is desirable for the optical system to further have a second lens system that forms an image of the proximate light on the image pickup device. It is possible to correct various aberrations in the proximate light generated by the first lens system that is optimized for visible light using the second lens system. This means that it is easy to use a construction where the first lens system is further optimized as an optical system for visible light and possible to provide a high performance optical system.

It is desirable for the first lens system to form the proximate light into an intermediate image between the first lens system and the second lens system and for the second lens system to form the intermediate image into a final image. By reforming the intermediate image of the proximate light, which is formed in the periphery of a position conjugated with the light modulating device, as a final image using the second lens system, it is possible to adjust the image formation magnification of the final image. This means that it is possible to reduce the size of the final image relative to the intermediate image and easy to reduce the size of the image pickup device relative to the light modulating device.

The optical device may include a first optical element that outputs the proximate light in a direction perpendicular to the optical path of the first lens system. It is possible to provide an optical system that as a whole has an L-shaped layout.

The optical device may include a second optical element that outputs the proximate light outputted from the first optical element in a direction that is parallel to the optical path of the first lens system. By outputting the proximate light outputted in a direction perpendicular to the optical axis of the first lens system using the first optical element in a direction parallel to the optical path of the first lens system using the second lens system, it is possible to provide a compact optical system that as a whole has a U-shaped layout.

Typically, it is desirable for the proximate light to be near infrared light and possible to form a near infrared image on the image pickup device.

Another aspect of the present invention is an apparatus having the optical system described above, the light modulating device; and the image pickup device. It is desirable for the apparatus to further include a control unit that changes first image data supplied to the light modulating device based on second image data obtained by the image pickup device.

It is desirable for the control unit to include a first unit operable, when a human body shape or face shape not included in the first image data is present in the second image data, to supply, to the light modulating device, image data in which a part of the first image data corresponding to the human body shape or face shape is blacked out. As one example, it is possible to provide an apparatus capable of suppressing projection of projection light onto a person or face when a person has intruded between the apparatus and the screen on the projection side. In addition, since the first lens system is commonly used for projection and image pickup, it is possible to reduce fluctuation in image angle between the projection images and picked up images and precisely detect intrusion by a person or the like.

It is desirable for the control unit to include a second unit operable, when information not included in the first image data, is present in the second image data, to supply image data where the information has been added to the first image data, to the light modulating device. Typically, it is possible to provide an apparatus where an image for a highlighted display, such as an underline, can be added along a path traced by a laser pointer.

### BRIEF DESCRIPTION OF DRAWINGS

FIG. 1 is a diagram showing an overview of an apparatus that uses an optical system according to a first embodiment.

FIG. 2 is a diagram showing the overall configuration of the optical system according to the first embodiment.

FIG. 3 is a diagram showing lens data of a second lens system of the optical system according to the first embodiment.

FIG. 4 is a diagram showing the overall configuration of an optical system according to the second embodiment.

FIG. 5 is a diagram showing lens data of a second lens system of the optical system according to the second embodiment.

### DETAIL DESCRIPTION

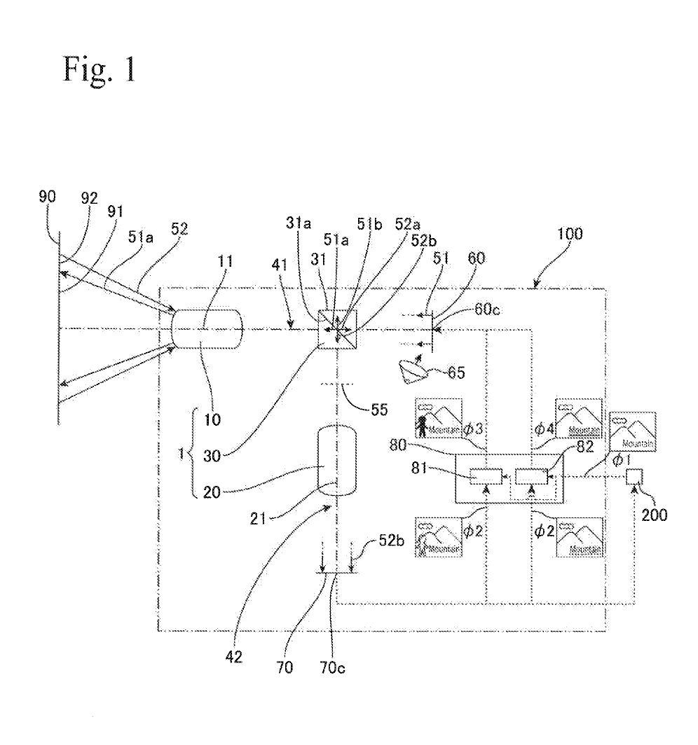

FIG. 1 shows an overview of an apparatus 100 that uses an optical system 1 according to a first embodiment of the present invention. The apparatus (projector apparatus) 100 is a projector apparatus equipped with an image pickup function and includes a light modulating device (light valve) 60, an illumination light optical system 65 that projects illumination light to be modulated onto the light valve 60, an optical system 1 that projects the image light formed by the light valve 60 onto a screen 90 located on a projection side and gathers image light that has been projected onto a screen 1, an image pickup device 70 disposed at a position where images are formed by the image light gathered by the optical system 1, and a control unit 80 that controls an output from the light valve 60 based on images picked up by the image pickup device 70.

The optical system 1 includes a first lens system (first optical system) 10, an optical device (light device) 30 disposed on a first optical path 41 along an optical axis 11 of the first lens system 10, and a second lens system (second optical system) 20 disposed between the optical device 30 and the image pickup device 70. The first lens system 10 enlarges and projects light (or “visible light” or “projection light”) 51a including wavelengths in the visible light band out of the first light 51 emitted from the light valve 60 onto a first region 91 of the screen 90 and gathers light flux propagating in an opposite direction to the projection light 51a, that is second light (or “image pickup light”) 52 from a second region 92 including the first region 91 and a peripheral region about the first region 91. The second light 52 includes visible light 52a and near infrared light 52b due to causes such as reflection and transmission from the screen 90 onto which images are projected and reflection of natural light (or light from lighting) in the periphery of the screen 90.

The optical device 30 in the present embodiment is a dichroic prism (first optical element) 31 and includes a first surface 31a that transmits light of the visible light band (i.e., “visible light”) with a wavelength of around 380 to 770 nm out of the incident light and, out of light of the non-visible light band, reflects light (near infrared light, or “proximate light”) including wavelengths in the near infrared light band with wavelengths of around 770 to 2500 nm that exceed the upper limit of the visible light band. That is, the first surface 31a transmits visible light but does not transmit light aside from visible light, that is, the proximate light that is proximate to the visible light band. Accordingly, out of the first light 51 incident from the light valve 60, the optical device 30 reflects near infrared light 51b at the first surface 31a to divert the near infrared light 51b away from the first optical path 41 and transmits visible light (projection light) 51a through the first surface 31a to guide the visible light 51a via the first optical path 41 to the first lens system 10. In addition, out of the second light 52 from the screen 90 that is incident via the first optical path 41, the optical device 30 transmits visible light 52a through the first surface 31a and reflects near infrared light (proximate light) 52b at the first surface 31a to divert (separate) the near infrared light 52b from the first optical path 41 and guides the near infrared light 52b to a second optical path 42 along an optical axis 21 of the second lens system 20. The second lens system 20 forms the image projected onto the screen 90 on the image pickup device 70 as a near infrared image.

Accordingly, in the optical system 1, it is possible to carry out projection and image pickup using the first lens system 10 without separately providing an optical system for projection and an optical system for image pickup. This means that it is possible to miniaturize and reduce the cost of the optical system 1. In addition, since projection and image pickup are carried out by making common use of the first lens system 10, there is little variation in parallax hence the projected images (i.e., the center 60c of the DMD 60) and the picked-up image (the center 70c of the image pickup device 70) substantially match. This means that by making adjustments to the projection angle, the focal distance, and the like to project sharp images onto the screen 90, it becomes possible to have the projected visible light images formed as sharp near infrared light images.

In addition, in the optical system 1, by guiding the near infrared light 52b to the separated second optical path 42 of the near infrared light 52b from the first optical path 41, it is possible to form images from the projected images using the near infrared light 52b. This means that it is not necessary to use the visible light 52a to form images of projected images. Accordingly, the visible light 51a does not need to be diverted from the first optical path 41. This means that it is possible to fully transmit the visible light 51a from the light valve 60 through the first optical path 41. Accordingly, it is possible to supply the first light 51 from the light valve 60 to the first lens system 10 without a drop in the amount of the visible light 51a. This means that it is possible to project bright, sharp visible images onto the first region 91 of the screen 90. Accordingly, it is easy to form near infrared images with a high contrast ratio.

In this way, in the optical system 1, the first lens system 10 is used in opposite directions for projection and for image pickup, with the incident side and exit side for visible light 51a and the incident side and exit side for proximate light 52b being reversed. This means that it is possible for the first lens system 10 to capture near infrared light 52b included in light flux that propagates in the opposite direction to the projection light 51a projecting toward the screen 90. In addition, the first lens system 10 is designed to have a high performance for visible light while, due to such design, various aberrations may occur for the near infrared light 52b incident on the first lens system 10, such aberrations are corrected by the second lens system 20. Accordingly, it is possible to provide the optical system 1 that is capable of high image quality for both the visible light that is projected and the near infrared light that is subjected to image pickup.

The projector apparatus 100 has the control unit (control circuit unit) 80 that receives first image data (image information, image signal) φ1 from a host PC (Personal Computer) 200, controls the light valve 60, and modulates illumination light (light flux) from the illumination optical system 65 on pixel (dot) by pixel basis using the light valve 60. The control unit 80 includes general-purpose resources for a computer, such as a CPU and memory, and realizes a variety of functions that control the first light 51 outputted from the light valve 60 according to a program (program product) stored in a memory, such as RAM.

The control unit 80 in the present embodiment includes a first unit 81 operable when the shape of a human body or face that is not included in first image data φ1 is present in second image data φ2 obtained from the image pickup device 70, to supply image data φ3 where a part corresponding to such shape of body or face in the first image data φ1 is blacked out to the light valve 60, and a second unit 82 operable when information that is not included in the first image data φ1 is present in the second image data φ2, to supply image data φ4 where such information has been added to the first image data φ1 to the light valve 60.

The first unit 81 receives the image information φ2 for a near infrared image that has been picked up, compares such image information φ2 with the desired image information φ1 from the host PC 200, generates, if a part that has been placed in shadow by a person or the like (i.e., a part that differs to the image information φ1) is included in the first region 91 of the image information φ2, the image information φ3 where the part placed in shadow has been blacked out and corrected (modified) and transmits such image information φ3 to the light valve 60. This means that when part of the first region 91 has been placed in shadow by a person intruding between the projector apparatus 100 and the screen 90, it is possible to suppress the projection of the first light 51 into such person's face or eyes and also to suppress the projection of the shadow of a person or the like onto the screen 90. In addition, since common use of the first lens system 10 is made for projection and image pickup, the image angles of the projected image and the picked-up images substantially match, and by comparing the image information φ1 and the image information φ2, it is possible to precisely detect intrusion by people and the like.

The second unit 82 receives the image information φ2, compares such image information φ2 with the desired image information φ1, generates, if a part that has been designated (illuminated) using a laser pointer (infrared pointer) or the like is included in the first region 91 of the image information φ2, image information φ4 that has been corrected by adding (superimposing) an image set in advance onto the image information φ1 at the designated part, and transmits the image information φ4 to the light valve 60. This means that when part of the first region 91 has been indicated with a laser pointer or the like, the second unit 82 is capable of adding an image by outputting light of the image information φ4 where an image for a highlighted display, such as an underline, has been added to the image information φ1 along a path traced by a laser pointer in the first region 91. Note that the image information φ2 may be transmitted to the host PC 200 and the respective units 81, 82 may be realized on the host PC 200 side. Also, the control unit 80 may include a variety of units for realizing a variety of functions that control the first light 51 from the light valve 60. As one example, a function for so-called “virtual mouse operations” that enable various operations to be carried out by having the user touch (point at) the first region 91 of the screen 90, may be provided.

Note that the projector apparatus 100 may be a front projector or may be a rear projector that includes a screen. The light valve (light modulating device) 60 of the projector apparatus 100 may be any device capable of forming images such as a DMD (digital micromirror device), a reflective LCD, a transmissive LCD, a LCoS, or an organic EL device, and may be a single panel or may use a method where images of the respective colors are separately formed by three panel. The image pickup device (image pickup element) 70 may be a CCD (monochromatic CCD), a CMOS sensor, or the like that is sensitive for the wavelengths of near infrared band and is capable of converting a near infrared image to an electric signal (image data), with it being possible to use a quantum (cooled) type device, such as a photodiode or a phototransistor, or a thermal (uncooled) device such as a bolometer or a microbolometer. The screen 90 may be a white board, a wall, a table surface, or the like. A typical projector apparatus 100 is a single-panel video projector that uses a DMD as the light valve 60. The illumination optical system 65 includes a white light source, such as a halogen lamp or an LED lamp, and a rotating color splitting filter (color wheel) in the form of a disc, with the DMD 60 forming images of the three primary colors red, green, and blue according to time division.

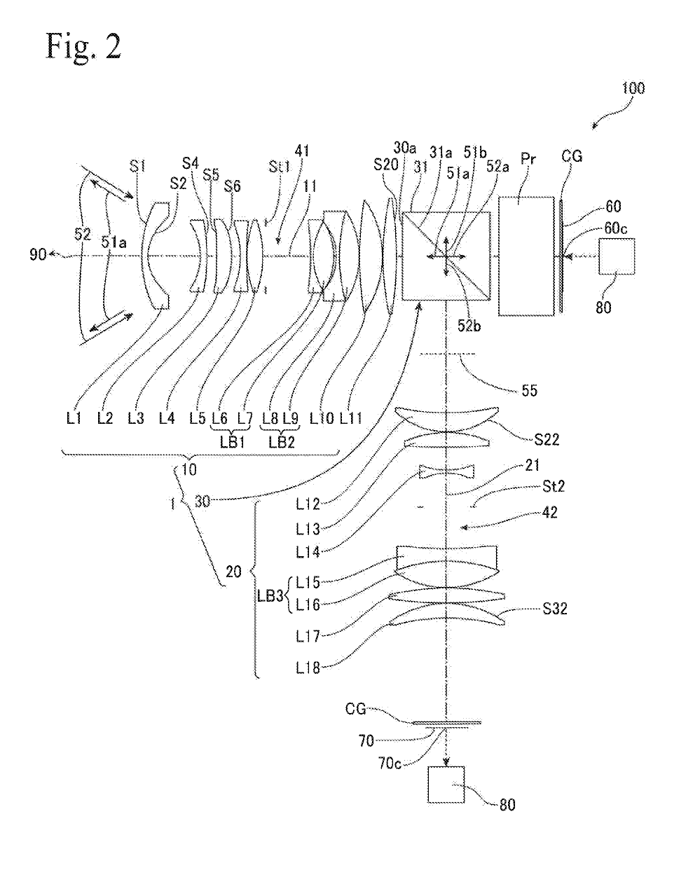

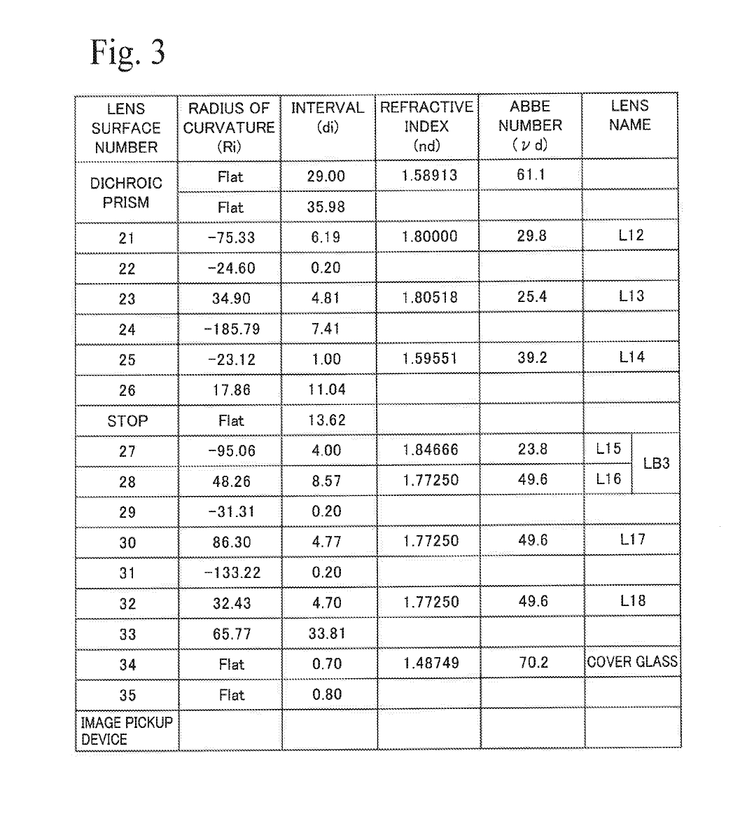

FIG. 2 shows the overall configuration of the optical system 1. FIG. 3 shows lens data of the second lens system 20 of the optical system 1. In the lens data, “Ri” represents the radius of curvature (mm) of each lens (i.e., each lens surface) disposed in order from the optical device (dichroic prism) 30 side, “di” represents the distance (mm) between the respective lens surfaces disposed in order from the optical device 30 side, “nd” represents the refractive index (d line) of each lens disposed in order from the optical device 30, and “vd” represents the Abbe number (d line) of each lens disposed in order from the optical device 30 side. The same also applies to the following embodiments. The optical system 1 includes the first lens system 10 that emits the visible light 51a that is incident from the light valve 60 side toward the screen 90, the optical device 30 that separates the proximate light 52b incident on the first lens system 10 from the screen 90 side from the optical path (first optical path) 41 of the first lens system 10, and the second lens system 20 that forms an image with the proximate light 52b, which has been separated by the optical device 30, on the image pickup device 70.

The first lens system 10 is an optical system that as a whole is constructed from eleven glass lenses and is constructed, in order from the screen 90 side (projection side) toward the DMD 60 side, of a negative meniscus lens L1 whose convex surface S1 is oriented toward the screen 90 side, a negative meniscus lens L2 whose convex surface S4 is oriented toward the DMD 60 side, a positive meniscus lens L3 whose convex surface S6 is oriented toward the DMD 60 side, a biconcave negative lens L4, a biconvex positive lens L5, a stop St1, a cemented lens (balsam lens) LB1 where two lenses are stuck together, a cemented lens LB2 where two lenses are stuck together, a biconvex positive lens L10, and a biconvex positive lens L11. On the DMD 60 side of the positive lens L11, in order from the screen 90 side, the optical device 30 and the DMD 60 are disposed with a TIR prism Pr and a cover glass CG in between. The cemented lens LB1 is constructed of a biconcave negative lens L6 and a biconvex positive lens L7 that are disposed in that order from the screen 90 side. The cemented lens LB2 is constructed of a biconcave negative lens L8 and a biconvex positive lens L9 that are disposed in that order from the screen 90 side. Both surfaces of the negative lens L1, that is, the convex surface S1 on the screen 90 side and the concave surface S2 on the DMD 60 side, are aspherical. Both surfaces of the positive lens L3, that is, the concave surface S5 on the screen 90 side and the convex surface S6 on the DMD 60 side are aspherical. In addition, antireflection films for improving the transmissivity for the wavelength bands of visible light and near infrared light are stuck onto every surface S1 to S20 of every lens L1 to L11 that construct the first lens system 10 and also to the surface 30a on the screen 90 side of the optical device 30. It is also possible to apply an antireflection film to at least one surface out of the surfaces S1 to S20 and 30a. In the optical system 1, the center 60c of the DMD 60 matches the optical axis 11 of the first lens system 10.

The second lens system (relay optical system) 20 is an optical system constructed of a total of seven glass lenses, and is constructed, in order from the optical device 30 side to the image pickup device 70 side, a positive meniscus lens L12 whose convex surface S22 is oriented toward the image pickup device 70, a biconvex positive lens L13, a biconcave negative lens L14, a stop St2, a cemented lens LB3 where two lenses are stuck together, a biconvex positive lens L17, and a positive meniscus lens L18 whose convex surface S32 is oriented toward the optical device 30 side. The image pickup device 70 is disposed on the image pickup device 70 side of the positive lens L18 with a cover glass CG in between. The cemented lens LB3 is constructed of a biconcave negative lens L15 and a biconvex positive lens L16 that are disposed in that order from the optical device 30 side. In the optical system 1, the center 70c of the image pickup device 70 matches the optical axis 21 of the second lens system 20.

In this optical system 1, the first lens system 10 forms an image of the near infrared light 52b, which is guided via the optical device 30 to the second lens system 20, as an intermediate image (image in space) 55 on the second optical path 42, and the second lens system 20 reforms the near infrared light 52b from the intermediate image 55 as a final image (near infrared image) on the image pickup device 70. This means that it is easy to adjust the image forming magnification of the near infrared image that is the final image. Accordingly, it is possible to reduce the size of the near infrared image relative to the intermediate image 55 and to also reduce the size of the image pickup device 70 relative to the DMD 60.

In addition, the second lens system 20 has the lenses L12 and L13 with positive refractive power, the lens L14 with negative refractive power, the stop St2, the lens L15 with negative refractive power, and the lenses L16 to L18 with positive refractive power disposed in order from the optical device 30 side toward the image pickup device 70 side, producing a so-called “Gauss-type” lens arrangement with a symmetrical balance of power for lenses on both sides of the stop St2. This means that it is easy for various aberrations such as curvature of field and distortion to offset and cancel each other out before and after the stop St2, so that various aberrations produced during the second light 52 traverses the first lens system 10 can be favorably corrected by the second lens system 20. Accordingly, it is possible to form sharp near infrared images in which various aberrations have been favorably corrected. In addition, it is easy to design a configuration where the first lens system 10 is optimized as a lens system for projecting and possible to provide a high-performance optical system 1.

In addition, in the optical system 1, the dichroic prism 31 outputs the proximate light 52b in a direction that is perpendicular to the visible light 51a (the first optical path 41). That is, in the optical system 1, the first optical path 41 extends in a straight line and the second optical path 42 extends perpendicularly to the first optical path 41. Accordingly, it is possible to provide the optical system 1 which as a whole has an L-shaped layout.

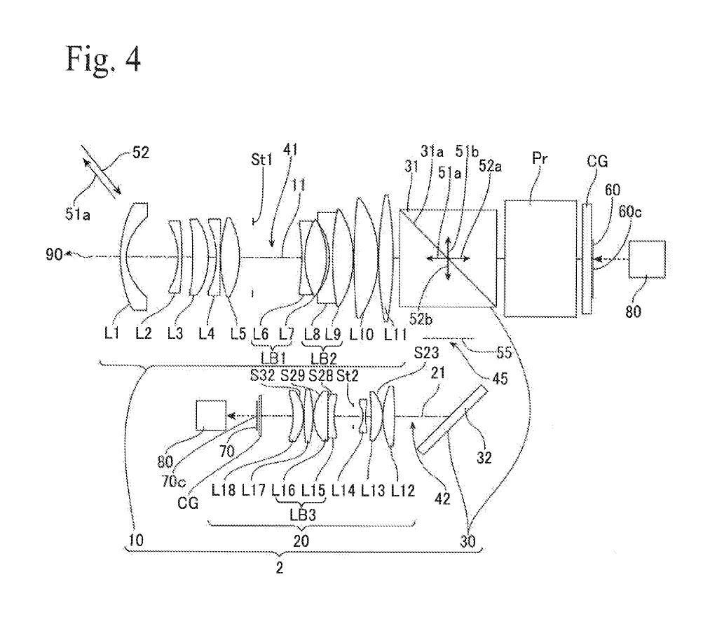

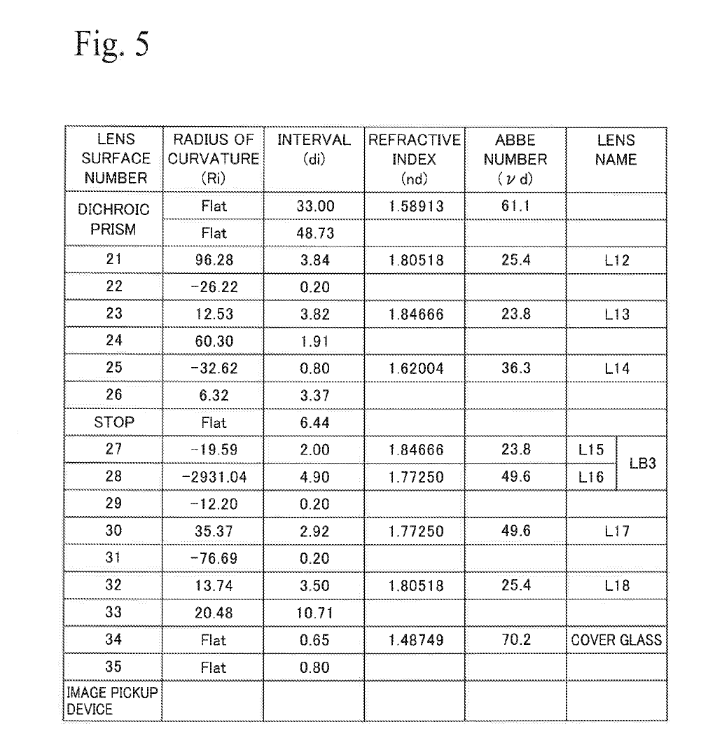

FIG. 4 shows the overall configuration of an optical system 2 according to a second embodiment of the present invention. FIG. 5 shows lens data of the second lens system 20 of the optical system 2. The optical system 2 also includes the first lens system 10, the optical device 30, and the second lens system 20. Note that configurations that are the same as the embodiment described above have been assigned the same reference numerals and description thereof is omitted.

The optical device 30 in the present embodiment includes the dichroic prism (first optical element) 31 disposed on the first optical path 41 and a mirror (second optical element) 32 that guides the proximate light 52b separated by the dichroic prism 31 to the second lens system 20. In this optical system 2, the dichroic prism 31 outputs the proximate light 52b in a direction perpendicular to the projection light 51a (the first optical path 41) and the mirror 32 outputs the proximate light 52b outputted from the dichroic prism 31 in a direction that is parallel to the projection light 51a (the first optical path 41). That is, in the optical system 2, the first optical path 41 extends in a straight line and the second optical path 42 extends in parallel to the first optical path 41. Accordingly, it is possible to provide a compact optical system 2 which as a whole has a U-shaped layout.

In the optical system 2, the first lens system 10 forms an image of the near infrared light 52b that is guided to the second lens system 20 as the intermediate image 55 in a space 45 from the dichroic prism 31 to the mirror 32 and the second lens system 20 reforms the near infrared light 52b with the intermediate image 55 that has been reflected by the mirror 32 on the image pickup device 70 as the final image (near infrared image). This means that it is easy to adjust the image forming magnification of the near infrared image that is the final image, and possible to reduce the size of the near infrared image relative to the intermediate image 55. Accordingly, it is possible to reduce the size of the image pickup device 70 relative to the DMD 60.

The first lens system 10 of the optical system 2 is equipped with the same lens configuration as the first lens system 10 according to the first embodiment. The second lens system 20 of the optical system 2 is constructed, in order from the mirror 32 side toward the image pickup device 70 side, of a biconvex positive lens L12, a positive meniscus lens L13 whose convex surface S23 is oriented toward the mirror 32 side, a biconcave negative lens L14, a stop St2, a cemented lens LB3 where two lenses are stuck together, a biconvex positive lens L17, and a positive meniscus lens L18 whose convex surface S32 is oriented toward the mirror 32 side. The cemented lens LB3 is constructed of a negative meniscus lens L15 whose convex surface S28 is oriented toward the image pickup device 70 side and a positive meniscus lens L16 whose convex surface S29 is oriented toward the image pickup device 70 side.

In this optical system 2, the second lens system 20 is constructed, in order from the mirror 32 side toward the image pickup device 70 side, of the lenses L12 and L13 with positive refractive power, the lens L14 with negative refractive power, the stop St2, the lens L15 with negative refractive power, and the lenses L16 to L18 that have positive refractive power, and has a Gauss-type lens arrangement with a symmetrical balance of power for lenses on both sides of the stop St2. This means that various aberrations produced when the first lens system 10 gathers the second light 52 can be favorably corrected by the second lens system 20. Accordingly, it is possible to improve the image forming performance for near infrared images and by designing a configuration where the first lens system 10 is optimized as a lens system for projecting, it is possible to provide a high-performance optical system 2.

In addition, in the optical system 2, the center 60c of the DMD 60 is disposed so as to be displaced from the optical axis 11 of the first lens system 10. The DMD 60 in the present embodiment is shifted (displaced) downward by around 5.7 mm from the optical axis 11 of the first lens system 10. This means that it is possible to carry out tilted projection (upward projection) toward the top of the screen 90, and to shift the first region 91 used for projection to the upper region of the second region 92 used for image pickup. Accordingly, it is possible to use the remaining region (the lower region) of the second region 92 for other purposes (for example, purposes like writing memos), and possible to carry out image pickup additionally for information written in the lower region. In addition, in the optical system 2, since the optical axis 21 of the second lens system 20 is shifted from the optical axis 11 of the first lens system 10, it is possible to reduce the lens diameters in the second lens system 20.

Note that the present invention is not limited to the embodiments described above and includes a scope that is defined by the range of the patent claims. Although the intermediate image 55 formed by the first lens system 10 is reformed as the final image by the second lens system 20 in the optical systems 1, 2 described above, it is also possible to dispose the image pickup device 70 at the position of the intermediate image 55 without providing the second lens system 20, and to form near infrared images on the image pickup device 70 using the first lens system 10. It is also possible to form near ultraviolet images on the image pickup device 70 using the optical device 30 that separates the light incident via the first optical path 41 into visible light and the near ultraviolet light. Also, the optical device 30 may be disposed inside the first lens system 10 and the near infrared light 52b may be separated at a position inside the first lens system 10.

Note that the optical device 30 may be a device that reflects visible light and transmits near infrared light out of the incident light (input light). It is sufficient for the optical device 30 to be a device capable of separating the incident light according to wavelengths into visible light and proximate light (near infrared light, near ultraviolet light), with it being possible to use a dichroic prism, a dichroic mirror, or the like. The optical systems 1, 2 may be equipped with a prism and a mirror (mirror surface) for bending the first optical path 41 and the second optical path 42 one or more times at appropriate positions. The first lens system 10 and the second lens system 20 may be a fixed focus type that does not carry out zooming or may be a variable focus (zoom) type that carries out zooming.

1. An optical system comprising:
a first lens system that emits light of a visible light band incident from a light modulating device side toward a projection side; and
an optical device that separates proximate light that is adjacent to the visible light band and is light of a non-visible light band that is incident on the first lens system from the projection side, from an optical path of the first lens system and outputs toward an image pickup device side.

2. The optical system according to claim 1,
further comprising a second lens system that forms an image of the proximate light on the image pickup device.

3. The optical system according to claim 2,
wherein the first lens system forms the proximate light into an intermediate image between the first lens system and the second lens system and the second lens system forms the intermediate image into a final image.

4. The optical system according to claim 1,
wherein the optical device includes a first optical element that outputs the proximate light in a direction perpendicular to the optical path.

5. The optical system according to claim 4,
wherein the optical device includes a second optical element that outputs the proximate light outputted from the first optical element in a direction that is parallel to the optical path.

6. The optical system according to claim 1,
wherein the proximate light is near infrared light.

7. An apparatus comprising:
the optical system according to claim 1,
the light modulating device; and
the image pickup device.

8. The apparatus according to claim 7,
further comprising a control unit that changes first image data supplied to the light modulating device based on second image data obtained by the image pickup device.

9. The apparatus according to claim 8,
wherein the control unit includes a first unit operable, when a human body shape or face shape not included in the first image data is present in the second image data, to supply, to the light modulating device, image data in which a part of the first image data corresponding to the human body shape or face shape is blacked out.

10. The apparatus according to claim 8,
wherein the control unit includes a second unit operable, when information not included in the first image data, is present in the second image data, to supply image data where the information has been added to the first image data, to the light modulating device.

11. An optical system comprising:
a first lens system that emits light of a visible light band incident from a light modulating device side toward a projection side, the first lens system located along a first optical path; and
an optical device that separates proximate light that is adjacent to the visible light band and is light of a non-visible light band that is incident on the first lens system from the projection side, from the first optical path and outputs the proximate light along a second optical path toward an image pickup device side.

12. The optical system according to claim 11,
further comprising a second lens system located along the second optical path and that forms an image of the proximate light on the image pickup device.

13. The optical system according to claim 12,
wherein the first lens system forms the proximate light into an intermediate image between the first lens system and the second lens system and the second lens system forms the intermediate image into a final image.

14. The optical system according to claim 11,
wherein the proximate light is near infrared light.

15. An apparatus comprising:
the optical system according to claim 11,
the light modulating device; and
the image pickup device.
